(19) United States
(12) Patent Application Publication
(10) Pub. No.: US 2026/0121350 A1
(43) Pub. Date: Apr. 30, 2026

(54) MATING ASSIST MECHANISM

(71) Applicant: JAPAN AVIATION ELECTRONICS INDUSTRY, LIMITED, Tokyo (JP)

(72) Inventor: Junji OOSAKA, Tokyo (JP)

(73) Assignee: JAPAN AVIATION ELECTRONICS INDUSTRY, LIMITED, Tokyo (JP)

(21) Appl. No.: 19/319,922

(22) Filed: Sep. 5, 2025

(30) Foreign Application Priority Data
Oct. 31, 2024 (JP) 2024-192236

(51) Int. Cl. H01R 13/641; H01R 12/71; H01R 13/627; H01R 13/631

(52) U.S. Cl. CPC H01R 13/641; H01R 13/6273; H01R 13/631; H01R 12/716

(57) ABSTRACT

A mating assist mechanism includes a first structure and a second structure. The first structure has two guide portions and a first piece. The second structure has a second piece. The guide portion guides a second connector toward a first connector when the second connector is mated with the first connector. At least one of the first piece and the second piece is resiliently deformable. The first piece has a first protrusion. The second piece has a second protrusion. When the second connector is mated with the first connector, the first protrusion and the second protrusion are brought into abutment with each other and then pass over each other in accordance with resilient deformation of at least one of the first piece and the second piece, and thereby a click feeling is generated.

### CROSS REFERENCE TO RELATED APPLICATIONS

This application is based on and claims priority under 35 U.S.C. § 119 to Japanese Patent Application No. JP 2024-192236 filed Oct. 31, 2024, the content of which is incorporated herein in its entirety by reference.

### BACKGROUND OF THE INVENTION

This invention relates to a mating assist mechanism configured to assist a mating operation of two connectors mateable with each other.

For example, this type of mating assist mechanism is disclosed in JP2011-129459A (Patent Document 1), the content of which is incorporated herein by reference.

Referring to FIG. 19, Patent Document 1 discloses a mating guide component (guide component) 90 configured to guide mating of a connector with a mating connector (not shown).

The connector 95 is mounted and fixed on a circuit board 98 in an up-down direction. The connector 95 is provided with a plurality of lock portions 97. Each of the lock portions 97 is located at a lower edge of the connector 95. The guide component 90 is provided with a plurality of lock claws 92 which correspond to the lock portions 97, respectively. When the illustrated guide component 90 is moved toward the connector 95, each of the lock claws 92 is moved under the corresponding lock portion 97 and is engaged with the corresponding lock portion 97. The thus-moved guide component 90 is attached to the connector 95. The mating connector (not shown) is mateable from above with the connector 95 to which the guide component 90 is attached. The guide component 90 guides the mating connector when the mating connector is mated with the connector 95. Thus, the connector 95 is provided with a mating assist mechanism comprising the guide component 90.

It is not easy for a user who is not mature in a mating operation to mate two connectors mounted on two circuit boards, respectively, with each other even though a mating assist mechanism such as that of Patent Document 1 is provided.

### SUMMARY OF THE INVENTION

It is therefore an object of the present invention to provide a mating assist mechanism configured to assist a mating operation performed by a user who is not mature in a mating operation.

An aspect of the present invention provides a mating assist mechanism configured to assist a mating operation of a first connector and a second connector which are mounted on a first object and a second object, respectively, and are mateable with each other along an up-down direction. The mating assist mechanism comprises a first structure configured to be attached to the first object and a second structure configured to be attached to the second object. The first structure comprises two guide portions and at least one first piece. The second structure comprises at least one second piece. The guide portion is configured to guide the second connector toward the first connector when the second connector is mated with the first connector. At least one of the first piece and the second piece is resiliently deformable. The first piece has a first protrusion. The second piece has a second protrusion. When the second connector is mated with the first connector, the first protrusion and the second protrusion are brought into abutment with each other and then pass over each other along the up-down direction in accordance with resilient deformation of the at least one of the first piece and the second piece, and thereby a click feeling is generated.

Another aspect of the present invention provides a predetermined member usable as the second structure of the mating assist mechanism. The predetermined member comprises two second pieces, two protection portions corresponding to the two second pieces, respectively, a coupling portion, an extending portion and a suckable portion. The two second pieces are apart from each other in a horizontal direction. Each of the second pieces is resiliently deformable. Each of the protection portions is adjacent to a corresponding one of the second pieces in an intersecting direction intersecting with the horizontal direction. The coupling portion couples the two protection portions together in the horizontal direction. The extending portion extends from the coupling portion along an extending direction so as to be located inside the predetermined member, the extending direction intersecting with the horizontal direction. The suckable portion is connected to the extending portion, is located between the two protection portions in the horizontal direction and extends along a horizontal plane defined by the horizontal direction and the intersecting direction.

The mating assist mechanism according to an aspect of the present invention comprises an informing mechanism in addition to a guide mechanism. The guide mechanism comprises the guide portions configured to guide mating of the first connector with the second connector. The informing mechanism comprises the first piece and the second piece configured to generate a click feeling when the first connector and the second connector are mated with each other. The thus-generated click feeling clearly informs a user that the first connector and the second connector are mated with each other. Moreover, the first piece and the second piece of an aspect of the present invention can be formed separately from the first connector and the second connector. For example, an intense click feeling can be generated by enlarging the size of each of the first piece and the second piece. Thus, an aspect of the present invention provides a mating assist mechanism configured to assist a mating operation performed by a user who is not mature in a mating operation.

An appreciation of the objectives of the present invention and a more complete understanding of its configuration may be had by studying the following description of the preferred embodiment and by referring to the accompanying drawings.

### BRIEF DESCRIPTION OF THE DRAWINGS

FIG. 1 is an exploded, perspective view showing a first device and a second device of a connection device according to an embodiment of the present invention together with a first object and a second object, wherein a part of a first structure of the first device enclosed by dashed line and a part of a second structure of the second device enclosed by dashed line are enlarged and illustrated.

FIG. 2 is a side view showing the connection device of FIG. 1, wherein the first device is mounted and fixed on an upper surface of the first object, the second device is mounted and fixed on a lower surface of the second object, a first connector of the first device and a second connector of the second device are under a separated state where they are separated from each other, and a position of the hidden first connector and a hidden outline of a second piece of the second connector are illustrated with dashed line.

FIG. 3 is a perspective view showing the connection device of FIG. 2, wherein the first connector and the second connector are under a mated state where they are mated with each other.

FIG. 4 is a top view showing the connection device of FIG. 3.

FIG. 5 is a cross-sectional view showing the connection device of FIG. 4, taken along line V-V.

FIG. 6A is a side view showing a positional relation between a first piece and the second piece of the connection device of FIG. 5, wherein the connection device is under the separated state.

FIG. 6B is a side view showing a positional relation between the first piece and the second piece of the connection device of FIG. 5, wherein the connection device is under a middle state between the separated state and the mated state, and an outline of the second piece before resilient deformation is illustrated with dashed line.

FIG. 6C is a side view showing a positional relation between the first piece and the second piece of the connection device of FIG. 5, wherein the connection device is under the mated state.

FIG. 7 is a perspective view showing the first device of FIG. 2.

FIG. 8 is a top view showing the first device of FIG. 7.

FIG. 9 is a side view showing the first device of FIG. 7, wherein hidden outlines of fixation members of the first structure are illustrated with dashed line.

FIG. 10 is a bottom view showing the first device of FIG. 7.

FIG. 11 is a top view showing the first structure of the first device of FIG. 7, wherein an example position of the second connector under the middle state is illustrated with dashed line.

FIG. 12 is a bottom view showing the first structure of FIG. 11, wherein a position of the first connector attached to the first structure is illustrated with dashed line.

FIG. 13 is a perspective view showing the second device of FIG. 2.

FIG. 14 is a bottom view showing the second device of FIG. 13, wherein example outlines of guide portions of the first structure under the middle state are illustrated with dashed line.

FIG. 15 is a cross-sectional view showing the second device of FIG. 14, taken along line XV-XV, wherein a part of the second device enclosed by dashed line is enlarged and illustrated, and an outline of the first device under the middle state is partially illustrated with dashed line.

FIG. 16 is a bottom view showing the second structure of the second device of FIG. 13, wherein a position of the second connector is illustrated with dashed line.

FIG. 17 is a perspective view showing a modification of the second structure of FIG. 16, wherein an outline of the second object is illustrated with dashed line, a part of the second structure enclosed by chain dotted line is enlarged and illustrated, and in the enlarged view, a hidden outline of a broken surface is illustrated with dashed line.

FIG. 18 is a perspective view showing a predetermined member usable as the second structure of FIG. 16, wherein an outline of the second object is illustrated with dashed line.

FIG. 19 is a perspective view showing a connector and a guide component of Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

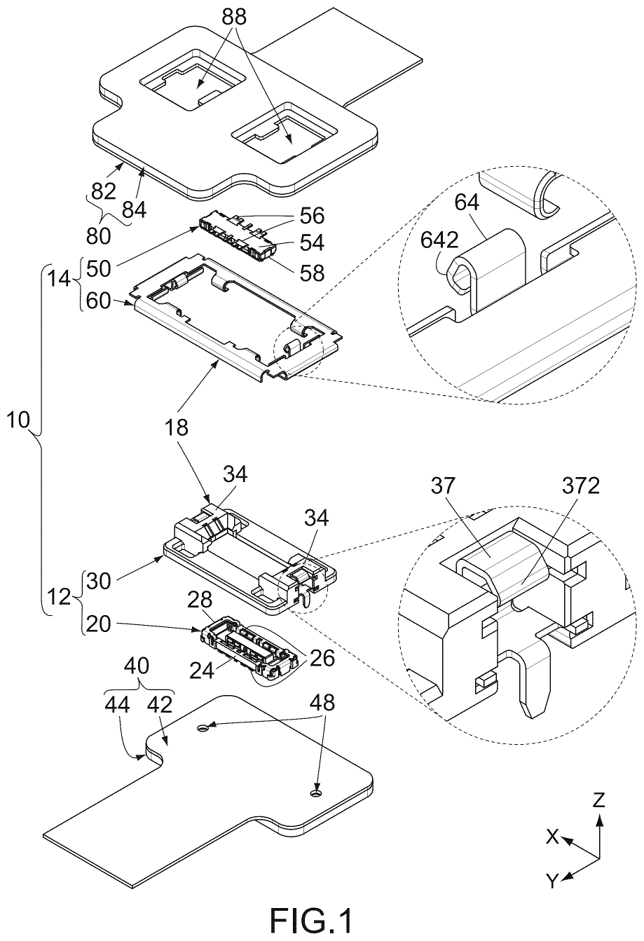

As shown in FIG. 1, a connection device 10 according to an embodiment of the present invention comprises a first device 12 and a second device 14. The first device 12 comprises a first connector 20 and a first structure 30. The first connector 20 and the first structure 30 are configured to be arranged on an upper surface of a first object 40 in an up-down direction. The second device 14 comprises a second connector 50 and a second structure 60. The second connector 50 and the second structure 60 are configured to be arranged on a lower surface of a second object 80. Thus, the connection device 10 of the present embodiment comprises the first connector 20, the first structure 30, the second connector 50 and the second structure 60. However, the present invention is not limited thereto. For example, the connection device 10 may further comprise another member in addition to the aforementioned members.

The up-down direction of the present embodiment is the Z-direction. In the present embodiment, “upward” means the positive Z-direction, and “downward” means the negative Z-direction. The words such as the up-down direction do not indicate the absolute positional relation relative to the ground but merely indicate a relative positional relation under a definition that the first device 12 is configured to be attached on an upper surface of the first object 40.

Hereafter, explanation will be made about the first connector 20 and the first object 40 of the present embodiment.

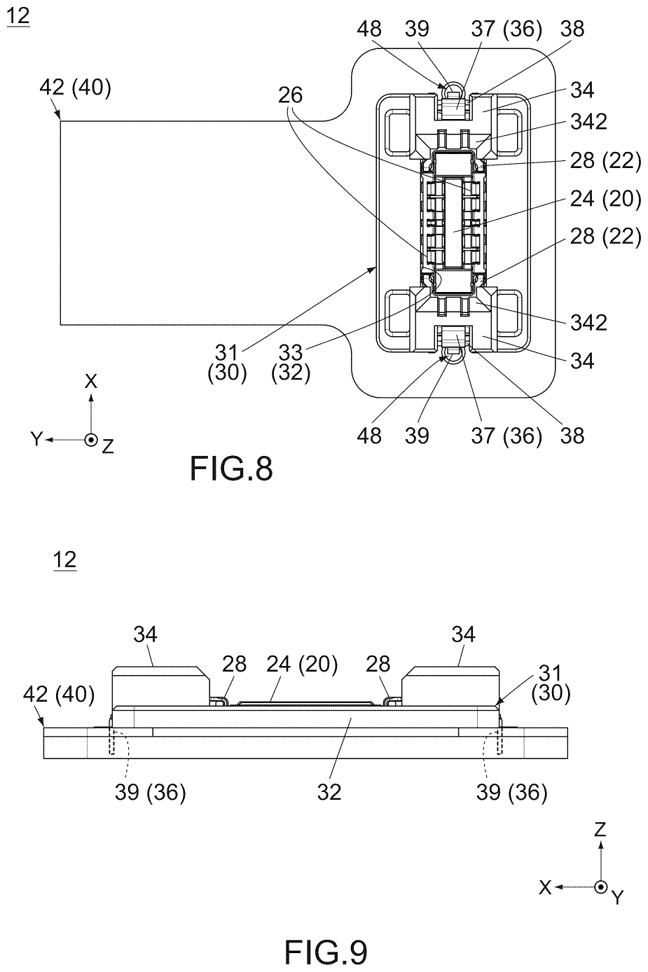

Referring to FIGS. 7 and 8, the first connector 20 of the present embodiment comprises a first housing 24 made of insulator, a plurality of first terminals 26 each made of conductor and two first hold-downs 28 each made of conductor. The first terminals 26 are held by the first housing 24 and are arranged in a horizontal direction perpendicular to the up-down direction. The horizontal direction of the present embodiment is the X-direction. The first hold-downs 28 are held by opposite end portions 22 of the first housing 24 in the horizontal direction, respectively. The first connector 20 of the present embodiment has the aforementioned configuration. However, the configuration of the first connector 20 of the present invention is not specifically limited.

The first connector 20 of the present embodiment is configured to be placed on the upper surface of the first object 40. Thus, the first connector 20 is a so-called on-board connector. The first object 40 of the present embodiment comprises a first circuit member 42 and a first reinforcement member 44. The first circuit member 42 is a flexible printed circuits (FPC) cable and is easily bendable. The first reinforcement member 44 is formed of a rigid body such as stainless steel and extends along a horizontal plane (XY-plane) perpendicular to the up-down direction.

The first reinforcement member 44 is fixed on a rear end part of a lower surface of the first circuit member 42 in a front-rear direction perpendicular to both the up-down direction and the horizontal direction and thereby reinforces the easily bendable first circuit member 42. The first circuit member 42 reinforced by the first reinforcement member 44 extends along the horizontal plane. The front-rear direction of the present embodiment is the Y-direction. In the present embodiment, “forward” means the positive Y-direction, and “rearward” means the negative Y-direction.

The first object 40 of the present embodiment has the aforementioned configuration. However, the present invention is not limited thereto. For example, the first circuit member 42 may be a rigid circuit board which is hardly bendable. In this instance, the first reinforcement member 44 does not need to be provided. Thus, the first object 40 may comprise only a rigid circuit board.

The first connector 20 of the present embodiment is mounted and fixed on the first object 40. In detail, the first terminals 26 and the first hold-downs 28 are fixed on and connected to conductive pads (not shown) of an upper surface of the first circuit member 42 via soldering. However, the first connector 20 may be fixed to the first object 40 by any method.

As shown in FIGS. 1, 8 and 10, the first object 40 of the present embodiment is formed with two fixation holes 48. Each of the fixation holes 48 passes through the first circuit member 42 and the first reinforcement member 44 of the first object 40 in the up-down direction. The fixation holes 48 are located at opposite sides of the first connector 20 in the horizontal direction, respectively, and are located at positions same as each other in the front-rear direction. The fixation holes 48 of the present embodiment are formed as described above. However, the present invention is not limited thereto. For example, the fixation holes 48 may be formed as necessary.

Hereafter, explanation will be made about the second connector 50 and the second object 80 of the present embodiment.

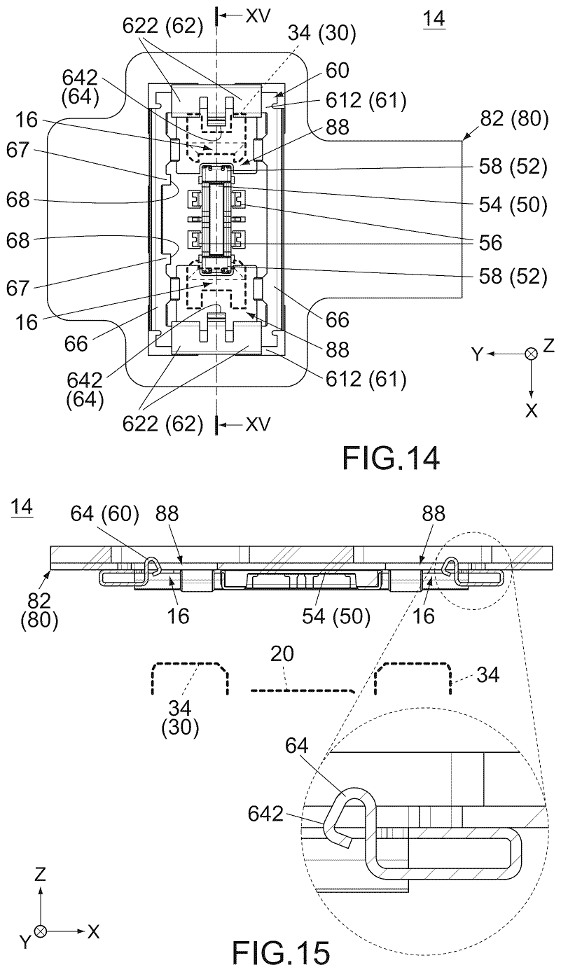

Referring to FIGS. 13 and 14, the second connector 50 of the present embodiment comprises a second housing 54 made of insulator, a plurality of second terminals 56 each made of conductor and two second hold-downs 58 each made of conductor. The second terminals 56 are held by the second housing 54 and are arranged along the horizontal direction. The second hold-downs 58 are held by opposite end portions 52 of the second housing 54 in the horizontal direction, respectively. The second connector 50 of the present embodiment has the aforementioned configuration. However, the configuration of the second connector 50 of the present invention is not specifically limited.

The second connector 50 of the present embodiment is configured to be placed on the lower surface of the second object 80. Thus, the second connector 50 is a so-called on-board connector. The second object 80 of the present embodiment comprises a second circuit member 82 and a second reinforcement member 84. The second circuit member 82 is an FPC cable and is easily bendable. The second reinforcement member 84 is formed of a rigid body such as stainless steel and extends along the horizontal plane. The second reinforcement member 84 is fixed on a front end part of an upper surface of the second circuit member 82 and thereby reinforces the easily bendable second circuit member 82. The second circuit member 82 reinforced by the second reinforcement member 84 extends along the horizontal plane.

The second object 80 of the present embodiment has the aforementioned configuration. However, the present invention is not limited thereto. For example, the second circuit member 82 may be a rigid circuit board which is hardly bendable. In this instance, the second reinforcement member 84 does not need to be provided. Thus, the second object 80 may comprise only a rigid circuit board.

The second connector 50 of the present embodiment is mounted and fixed on the second object 80. In detail, the second terminals 56 and the second hold-downs 58 are fixed on and connected to conductive pads of a lower surface of the second circuit member 82 via soldering. However, the second connector 50 may be fixed to the second object 80 by any method.

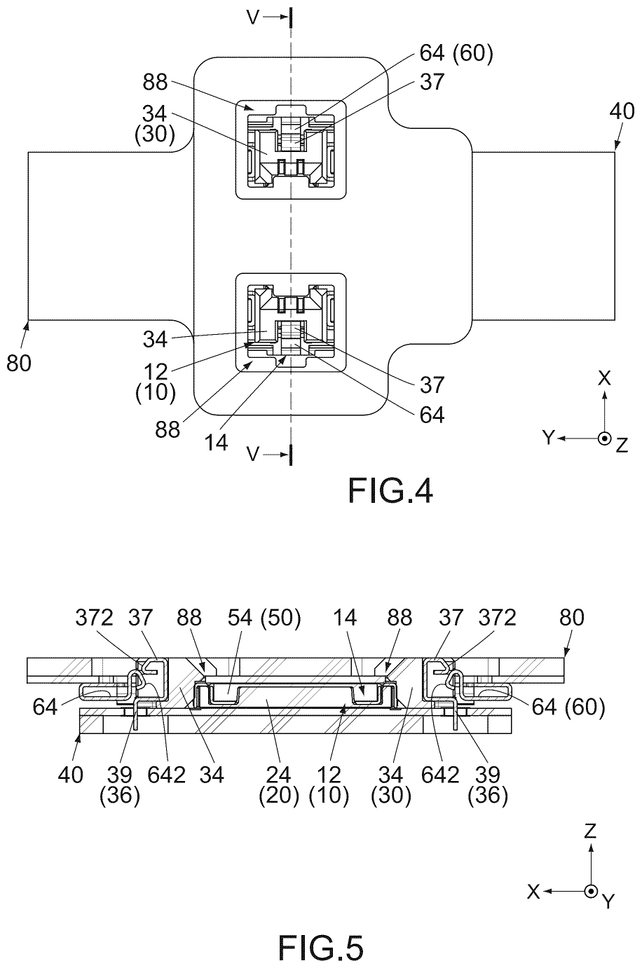

As shown in FIGS. 1 and 4, the second object 80 of the present embodiment is formed with two openings 88. Each of the openings 88 passes through the second circuit member 82 and the second reinforcement member 84 of the second object 80 in the up-down direction. Thus, each of the openings 88 passes through the second object 80 in the up-down direction. In other words, each of the openings 88 of the present embodiment opens upward and downward. The openings 88 are located at opposite sides of the second connector 50 in the horizontal direction, respectively, and are located at positions same as each other in the front-rear direction. The openings 88 of the present embodiment are formed as described above. However, the present invention is not limited thereto. For example, each of the openings 88 may open only downward. The openings 88 may be formed as necessary.

Hereafter, explanation will be made about a mating operation of the first connector 20 and the second connector 50 of the present embodiment. The mating operation described below is performed not by a machine but by a user who uses the connection device 10.

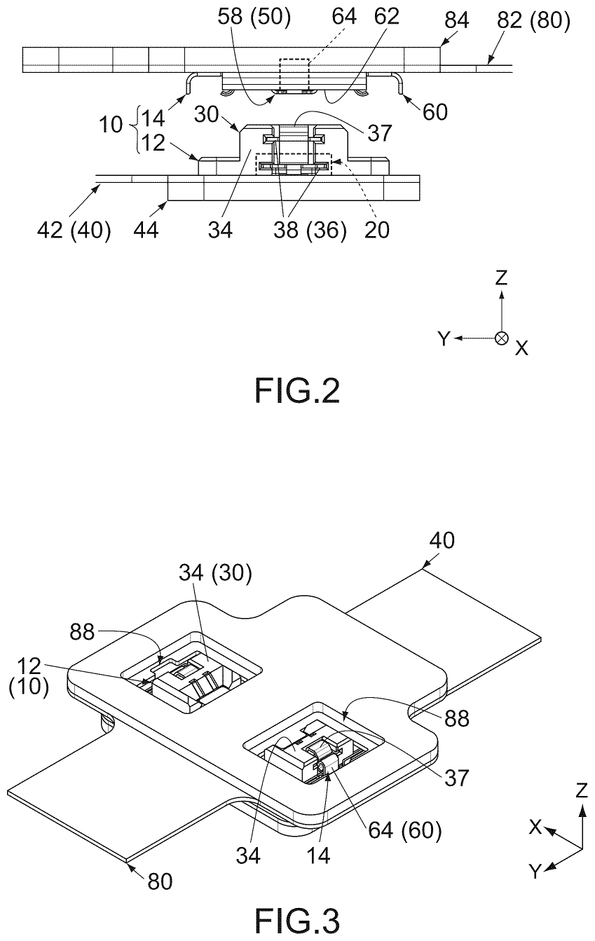

Referring to FIGS. 2 and 5 together with FIG. 1, the first connector 20 is mateable with the second connector 50 along the up-down direction under a state where the second connector 50 is located above the first connector 20 in the up-down direction. The first connector 20 of the present embodiment is a receptacle, and the second connector 50 of the present embodiment is a plug. Thus, the second connector 50 is partially received in the first connector 20 under a mated state where the first connector 20 and the second connector 50 are mated with each other as shown in FIG. 5. However, the present invention is not limited thereto. For example, the first connector 20 may be a plug, and the second connector 50 may be a receptacle.

Referring to FIG. 2 together with FIG. 1, the first connector 20 and the second connector 50 illustrated in FIG. 2 is under a separated state where they are separated from each other. Under the separated state, the second connector 50 is located above the first connector 20 and faces the first connector 20 in the up-down direction. Referring to FIGS. 2 to 5 together with FIG. 1, when the second object 80 is moved downward together with the second connector 50 which is mounted thereon and is under the separated state, the first connector 20 and the second connector 50 take a middle state (not shown) and then take the mated state (see FIGS. 3 to 5). Under the mated state, the first terminals 26 of the first connector 20 are connected to the second terminals 56 of the second connector 50, respectively, and thereby the first circuit member 42 is electrically connected with the second circuit member 82.

Referring to FIG. 1, the connection device 10 of the present embodiment comprises a mating assist mechanism 18. The mating assist mechanism 18 is configured to assist the mating operation of the first connector 20 and the second connector 50 which are mounted on the first object 40 and the second object 80, respectively, and are mateable with each other along the up-down direction. The mating assist mechanism 18 comprises the first structure 30 configured to be attached to the first object 40 and the second structure 60 configured to be attached to the second object 80. The first structure 30 forms the first device 12 together with the first connector 20 and is configured to be mounted on the first object 40 together with the first connector 20. The second structure 60 forms the second device 14 together with the second connector 50 and is configured to be mounted on the second object 80 together with the second connector 50.

Hereafter, explanation will be made about the first structure 30 of the present embodiment.

Referring to FIGS. 7, 8, 11 and 12, the first structure 30 of the present embodiment comprises a main member 31 made of insulator and two fixation members 36 each made of metal.

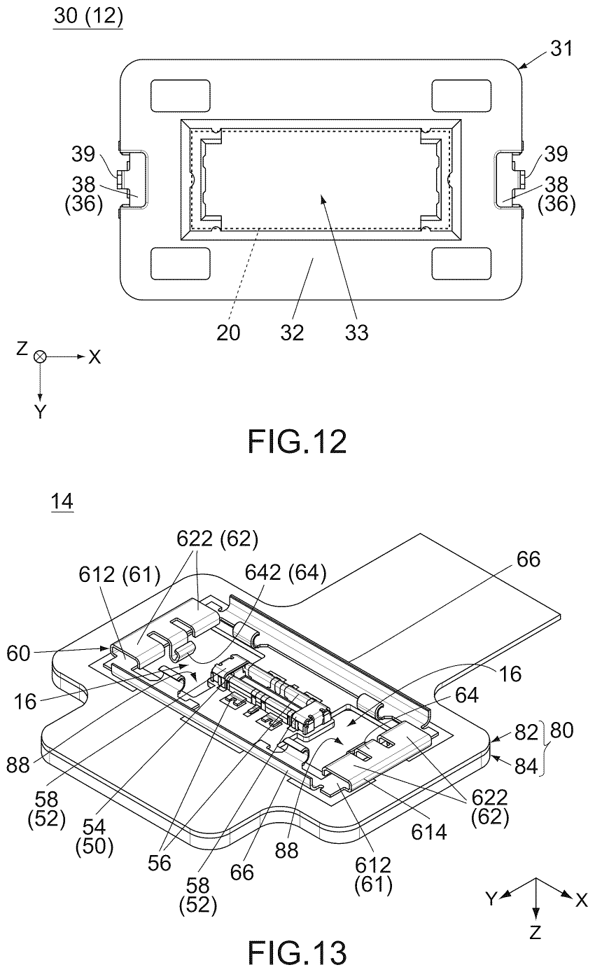

Referring to FIGS. 7, 9 and 11, the main member 31 of the present embodiment has a base 32 and two guide portions 34. Thus, the first structure 30 of the present embodiment comprises the base 32 and the two guide portions 34. The base 32 has a rectangular flat-plate shape perpendicular to the up-down direction. Referring to FIGS. 11 and 12, the base 32 is formed with an accommodation portion 33. The accommodation portion 33 is a space which has a rectangular shape in the horizontal plane. The accommodation portion 33 passes through the base 32 in the up-down direction and is enclosed by an inner wall surface of the base 32 in the horizontal plane. As shown in FIG. 11, the guide portions 34 are located at opposite sides of the base 32 in the horizontal direction, respectively, with the accommodation portion 33 located therebetween, and are located at positions same as each other in the front-rear direction. As shown in FIG. 9, each of the guide portions 34 projects upward beyond an upper surface of the base 32.

The main member 31 of the present embodiment has the aforementioned configuration. However, the present invention is not limited thereto. For example, the configuration of the main member 31 is not specifically limited, provided that the main member 31 is formed with the two guide portions 34. The guide portions 34 may be located at positions different from each other in the front-rear direction.

Referring to FIGS. 7 and 11, each of the fixation members 36 of the present embodiment is formed by bending a single metal plate. In other words, each of the fixation members 36 is a single metal plate with bends. The fixation members 36 are located at opposite sides of the main member 31 in the horizontal direction, respectively, and are held by the guide portions 34 of the main member 31, respectively.

Referring to FIG. 8, each of the fixation members 36 of the present embodiment has a first piece 37. As described later, each of the first pieces 37 is configured to generate a click feeling at the timing when the first connector 20 and the second connector 50 (see FIG. 5) are mated with each other. The click feeling may be a click sound or may be a tactile feeling felt by a user who performs the mating operation.

The first structure 30 of the present embodiment comprises the two first pieces 37. The two first pieces 37 are apart from each other in the horizontal direction. However, the present invention is not limited thereto. For example, the first structure 30 may comprise at least one first piece 37. The at least one first piece 37 may include two first pieces 37 or may include three or more first pieces 37.

Referring to FIG. 8 together with FIG. 7, each of the fixation members 36 of the present embodiment has a held portion 38 and a fixed portion 39 in addition to the first piece 37. Referring to FIGS. 2 and 7, each of the held portions 38 is press-fit into and held by the guide portion 34. Referring to FIGS. 7 and 9, each of the fixed portions 39 extends downward beyond a lower surface of the base 32.

Referring to FIG. 7, the first structure 30 of the present embodiment is configured to be attached from above to the first connector 20 which is mounted on the first object 40. The thus-attached first structure 30 is mounted on the upper surface of the first circuit member 42. Referring to FIG. 7 together with FIG. 12, when the first structure 30 is mounted on the first circuit member 42, the first connector 20 is lightly press-fit into and accommodated in the accommodation portion 33 of the first structure 30. The first connector 20 which is press-fit into the accommodation portion 33 can be accurately positioned relative to the first structure 30 in the horizontal plane. In other words, the first structure 30 attached to the first connector 20 is accurately positioned relative to the first connector 20 in the horizontal plane.

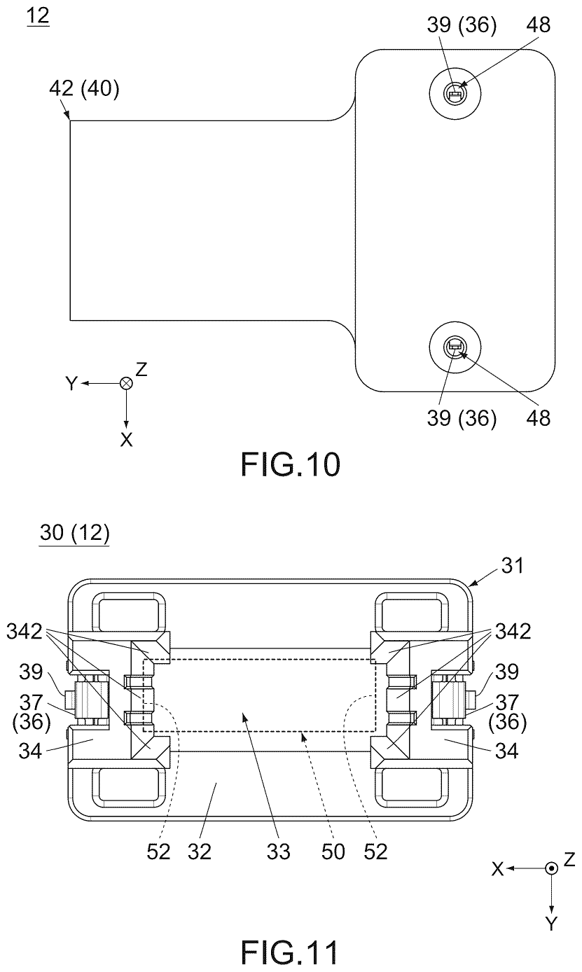

Referring to FIG. 10, the two fixation holes 48 of the first object 40 are located at positions in the horizontal plane which correspond to positions of the fixed portions 39 of the two fixation members 36 in the horizontal plane, respectively. When the first structure 30 is attached to the first connector 20, each of the fixed portions 39 is received in the fixation hole 48. The first structure 30 can be attached and fixed to the first object 40 by soldering the fixed portions 39 received in the fixation holes 48. Thus, the first structure 30 can be attached and fixed to the first object 40 without being fixed to the first connector 20. However, the first structure 30 may be attached to the first object 40 by any method.

Referring to FIGS. 8 and 9, the first structure 30 completely encloses the first connector 20 in the horizontal plane when the first structure 30 is attached to the first object 40. The base 32 has a size in the up-down direction which is slightly smaller than a size of the first connector 20 in the up-down direction. Accordingly, when the first structure 30 attached to the first object 40 is seen along the front-rear direction, the first connector 20 is invisible except for upper ends of the first hold-downs 28 and an upper end of the first housing 24.

Referring to FIG. 7, each of the portions of the present embodiment such as the guide portions 34 and the first pieces 37 is a part of the integrally assembled first structure 30. Thus, the portions such as the guide portions 34 and the first pieces 37 are positionally fixed to each other. According to the present embodiment, the portions such as the guide portions 34 and the first pieces 37 can be arranged on designed proper positions by merely attaching the single first structure 30 to the first connector 20. However, the present invention is not limited thereto. For example, the first structure 30 may be a mere collection of the guide portions 34 and the first pieces 37 separated from each other. However, in such an instance, each of the guide portions 34 and the first pieces 37 should be separately arranged on a proper position of the first object 40. The present embodiment is preferable from a viewpoint of easy and accurate arrangement of various portions on the first object 40.

Hereafter, explanation will be made about the second structure 60 (see FIG. 13) of the present embodiment.

Referring to FIG. 13, the second structure 60 of the present embodiment is formed by bending a single metal plate. In other words, the second structure 60 is a single metal plate with bends. The second structure 60 of the present embodiment comprises two main portions 61 and two coupling portions 66. The main portions 61 are apart from each other in the horizontal direction and extend in parallel to each other along the front-rear direction. The coupling portions 66 are apart from each other in the front-rear direction and extend in parallel to each other along the horizontal direction. Each of the coupling portions 66 couples front ends or rear ends of the two main portions 61 together in the horizontal direction. The thus-formed second structure 60 of the present embodiment has a close rectangular-frame shape in the horizontal plane.

The second structure 60 of the present embodiment has the aforementioned configuration. However, the present invention is not limited thereto. For example, the configuration of the second structure 60 is not specifically limited, provided that the second structure 60 comprises one of the main portions 61.

Referring to FIGS. 13 and 14, the second structure 60 of the present embodiment is configured to be mounted on the lower surface of the second object 80. In detail, the second structure 60 is configured to be attached and fixed to the lower surface of the second circuit member 82 via soldering so as to be apart from the second connector 50 in the horizontal plane and so as to enclose the second connector 50 in the horizontal plane. The second structure 60 attached to the second object 80 is accurately positioned relative to the second connector 50 in the horizontal plane. The second structure 60 of the present embodiment is configured to be securely attached and fixed to the second object 80. However, the second structure 60 may be attached to the second object 80 by any method.

Each of the main portions 61 of the present embodiment has a bottom plate 612, a side plate 614, a protection portion 62 and a second piece 64. Each of the bottom plates 612 is a flat plate in parallel to the horizontal plane and extends along the front-rear direction. Each of the side plates 614 protrudes downward from an outer edge of the bottom plate 612 in the horizontal direction and extends along the front-rear direction together with the bottom plate 612. Each of the protection portions 62 has two protection pieces 622. Each of the protection pieces 622 extends inward in the horizontal direction from a lower end of the side plate 614 and then extends upward.

In each of the main portions 61, the two protection pieces 622 are apart from each other in the front-rear direction, and the second piece 64 is located between the two protection pieces 622 in the front-rear direction. Each of the second pieces 64 extends inward in the horizontal direction from the lower end of the side plate 614 and then extends upward. Then, each of the second pieces 64 extends downward. Each of the second pieces 64 is resiliently deformable. In detail, each of the second pieces 64 has an outer end in the horizontal direction. The outer end of each of the second pieces 64 is a fixed end fixed to the protection pieces 622 and is hardly deformed resiliently. Each of the second pieces 64 except for the fixed end is a cantilever spring having a long spring length and is easily deformed resiliently.

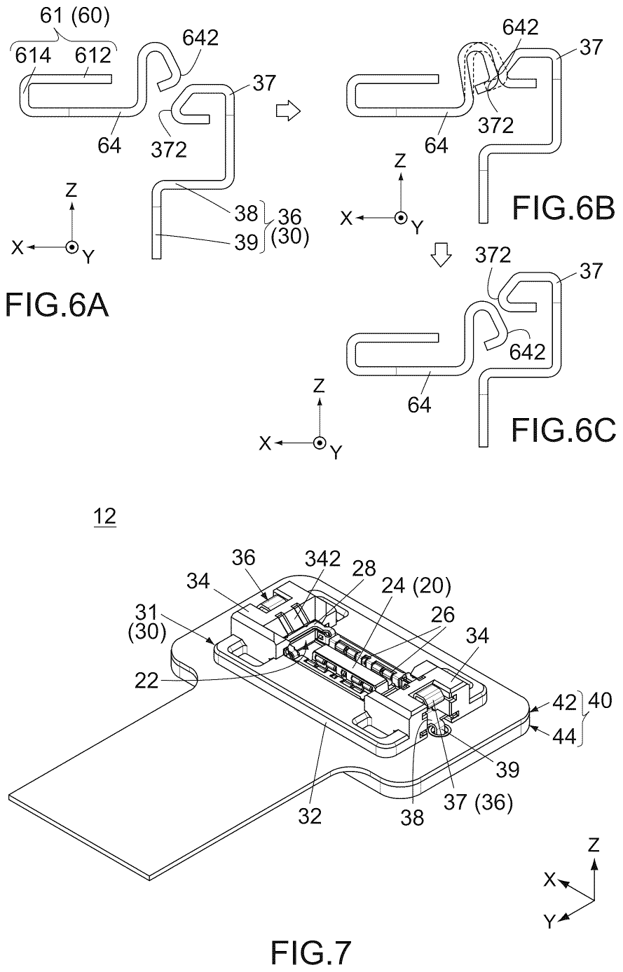

Referring to FIG. 5 together with FIG. 6, each of the second pieces 64 is configured to generate the click feeling in cooperation with the first piece 37 at the timing when the first connector 20 and the second connector 50 are mated with each other. The second structure 60 of the present embodiment comprises the two second pieces 64. The two second pieces 64 are apart from each other in the horizontal direction. However, the present invention is not limited thereto. For example, the second structure 60 may comprise at least one second piece 64. The at least one second piece 64 may include two second pieces 64 which correspond to the two first pieces 37, respectively, or may include three or more second pieces 64 which correspond to three or more of the first pieces 37, respectively.

Referring to FIGS. 13 and 14, when the second structure 60 is attached to the second object 80, an inner end of each of the protection portions 62 in the horizontal direction is partially located just under the second object 80. Referring to FIG. 2 together with FIG. 13, when the first connector 20 and the second connector 50 are mated with each other in an assumed instance in which the protection portions 62 are not provided, a part of the first structure 30 such as the guide portion 34 might be brought into abutment with the second piece 64, and thereby the second piece 64 might receive a large force. As a result, the second piece 64 might be damaged.

In contrast, the second structure 60 of the present embodiment comprises the two protection portions 62 which correspond to the two second pieces 64, respectively. Each of the protection portions 62 is adjacent to the corresponding second piece 64. According to this arrangement, even if a part of the first structure 30 is brought into abutment with the second piece 64 during a process in which the first connector 20 and the second connector 50 are mated with each other, the protection portion 62 receives the force. Even if the protection portion 62 is bent upward by the applied large force, the protection portion 62 is brought into abutment with the second circuit member 82 reinforced by the second reinforcement member 84, and thereby the force is distributed. According to the present embodiment, since the protection portions 62 are provided, the second pieces 64 can be prevented from being damaged. Thus, each of the protection portions 62 protects the corresponding second piece 64 when the second connector 50 is mated with the first connector 20.

Referring to FIGS. 13 and 14, each of the protection portions 62 of the present embodiment is adjacent to the corresponding second piece 64 in an intersecting direction perpendicular to the up-down direction and intersecting with the horizontal direction. In detail, each of the protection portions 62 has the two protection pieces 622 between which the corresponding second piece 64 is located in the intersecting direction. Each of the second pieces 64 is partially fixed to the two protection pieces 622 in the intersecting direction. Each of the protection pieces 622 has a lower end surface which is located at a position same as that of a lower end surface of the second piece 64 in the up-down direction.

The protection portions 62 of the present embodiment are arranged as described above so that the second pieces 64 can be more securely prevented from being damaged. The intersecting direction of the present embodiment is the front-rear direction perpendicular to the horizontal direction. However, the present invention is not limited thereto. For example, the intersecting direction may be a direction oblique to the horizontal direction. Each of the protection portions 62 may have only one of the protection pieces 622 which is adjacent to the corresponding second piece 64 in the intersecting direction. The lower end surface of each of the protection pieces 622 may be located below the lower end surface of the second piece 64 in the up-down direction. The protection portions 62 may be provided as necessary.

Each of the main portions 61 of the present embodiment has the aforementioned configuration. However, the configuration of each of the main portions 61 is not specifically limited, provided that each of the main portions 61 has one or more of the second pieces 64.

The two main portions 61 of the present embodiment are coupled together by the two coupling portions 66. In other words, each of portions such as the second pieces 64 and the protection portions 62 of the present embodiment is a part of the single second structure 60. Thus, the portions such as the second pieces 64 and the protection portions 62 are positionally fixed to each other. According to the present embodiment, the portions such as the second pieces 64 and the protection portions 62 can be arranged on designed proper positions by merely attaching the single second structure 60 to the second object 80. However, the present invention is not limited thereto. For example, the second structure 60 may be a mere collection of the second pieces 64 and the protection portions 62 separated from each other. However, in such an instance, each of the second pieces 64 and the protection portions 62 should be separately arranged on a proper position of the second object 80. The present embodiment is preferable from a viewpoint of easy and accurate arrangement of various portions on the second object 80.

The second structure 60 of the present embodiment comprises the two coupling portions 66. Each of the coupling portions 66 couples the two protection portions 62 together in the horizontal direction. According to this configuration, the second pieces 64 and the protection portions 62 can be easily arranged on proper positions. However, the present invention is not limited thereto.

For example, comparing FIG. 17 with FIG. 13, a second structure 60A according to a modification comprises only one of the coupling portions 66. The second structure 60A has a rear end part which opens in the horizontal direction. The thus-formed second structure 60A has an open rectangular-frame shape in the horizontal plane. According to this configuration, the second circuit member 82 can be provided with conductive lines (not shown) which are formed on the lower surface of the second circuit member 82 and are connected to the second connector 50. The second structure 60 of the present embodiment may comprise at least one coupling portion 66 similarly to the second structure 60A. The coupling portion 66 may couple the two protection portions 62 together in the horizontal direction. The least one coupling portion 66 may include two coupling portions 66 or may include three or more coupling portions 66.

Referring to FIG. 13, each of the coupling portions 66 has a horizontal portion which extends along the horizontal direction in parallel to the horizontal plane and a protruding portion which protrudes downward from an edge of the horizontal portion in the front-rear direction. According to this configuration, each of the coupling portions 66 is hardly bent. Accordingly, the second pieces 64 and the protection portions 62 can be easily kept at proper positions. However, the present invention is not limited thereto. For example, each of the coupling portions 66 may have only the horizontal portion.

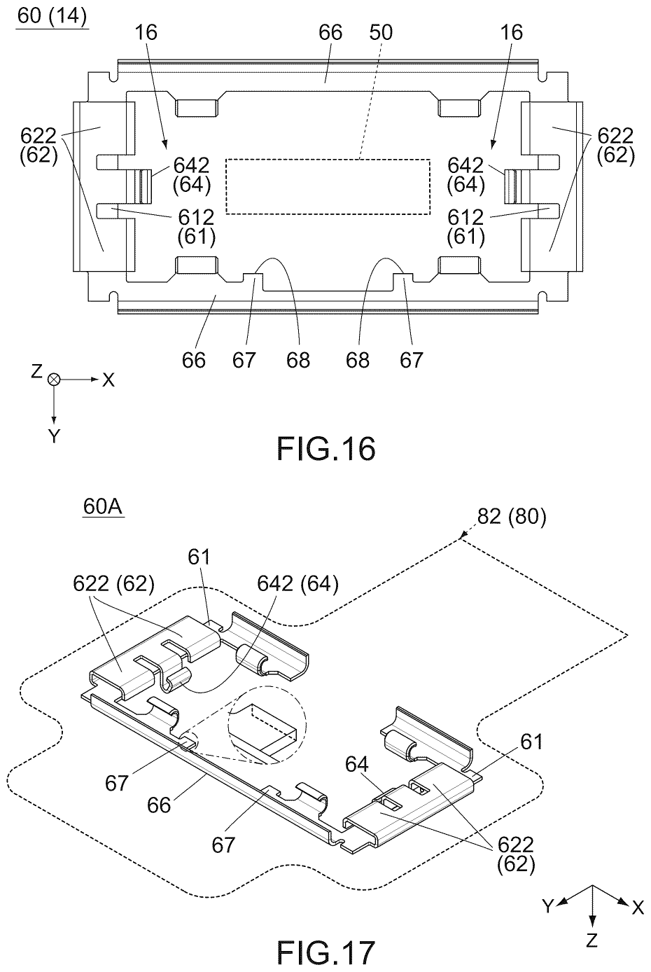

Referring to FIG. 16, the second structure 60 of the present embodiment comprises two extending portions 67. Each of the extending portions 67 extends from the front coupling portion 66 along an extending direction so as to be located inside the second structure 60 in the horizontal plane. The extending direction is perpendicular to the up-down direction and intersects with the horizontal direction. The two extending portions 67 are apart from each other in the horizontal direction. Each of the extending portions 67 is formed with a broken portion 68 located at an end (rear end) thereof. Each of the broken portions 68 has an end surface (broken surface) which is not applied with plating.

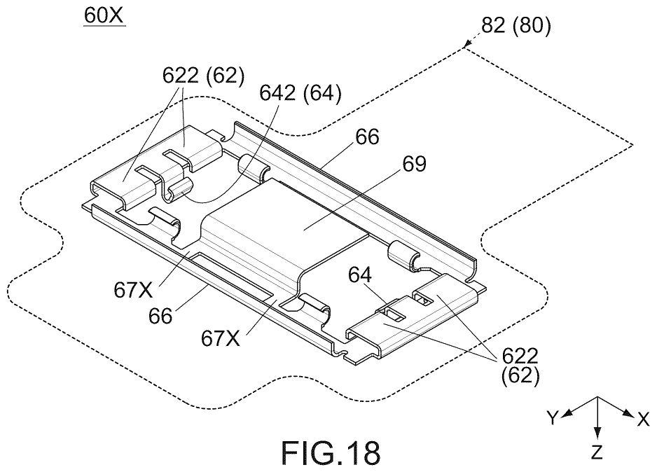

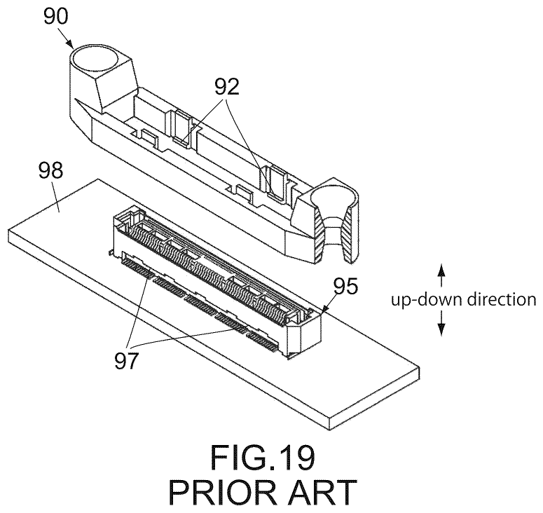

Referring to FIG. 18 together with FIG. 16, the second structure 60 of the present embodiment is formed of a predetermined member 60X. In other words, the predetermined member 60X is a member which is usable as the second structure 60 of the mating assist mechanism 18 (see FIG. 1). The predetermined member 60X has a configuration similar to that of the second structure 60. In detail, the predetermined member 60X comprises the two second pieces 64, the two protection portions 62 corresponding to the two second pieces 64, respectively, the two coupling portions 66, two extending portions 67X and a suckable portion 69. The predetermined member 60X comprises the extending portions 67X each of which is slightly longer than the extending portion 67 of the second structure 60. The predetermined member 60X comprises the suckable portion 69 which is not provided to the second structure 60. The predetermined member 60X has the configuration same as that of the second structure 60 except for the aforementioned differences.

More specifically, the two second pieces 64 are apart from each other in the horizontal direction. Each of the second pieces 64 is resiliently deformable. Each of the protection portions 62 is adjacent to the corresponding second piece 64 in the intersecting direction intersecting with the horizontal direction. Each of the coupling portions 66 couples the two protection portions 62 together in the horizontal direction. Each of the extending portions 67X extends from the front coupling portion 66 along the extending direction so as to be located inside the predetermined member 60X in the horizontal plane. The extending direction intersects with the horizontal direction. The suckable portion 69 is connected to the extending portions 67X, is located between the two protection portions 62 in the horizontal direction and extends along the horizontal plane defined by the horizontal direction and the intersecting direction. Each of the extending portion 67X is formed with a notch (not shown).

The predetermined member 60X is configured to be mounted on a predetermined position of the second object 80 by a suction conveyor (not shown) which sucks the suckable portion 69. The second structure 60 is formed by cutting off the suckable portion 69 at the notches (not shown) of the extending portions 67X after the predetermined member 60X is mounted on the second object 80. The broken portions 68 of the second structure 60 are marks at which the suckable portion 69 are cut off.

Referring to FIG. 16, the extending portions 67 of the present embodiment are formed as described above. The extending direction along which the extending portions 67 of the present embodiment extend is the front-rear direction perpendicular to the horizontal direction. However, the present invention is not limited thereto. For example, the extending direction may be a direction oblique to the horizontal direction. The number of the extending portions 67 may be one, three or more. Each of the extending portions 67 may extend from the rear coupling portion 66.

Referring to FIGS. 13 and 14, the two protection portions 62 of the present embodiment are arranged so that the second connector 50 is located therebetween in the horizontal direction. This arrangement forms two receiving spaces 16 which correspond to the two protection portions 62, respectively. The two receiving spaces 16 are spaces which are located under the two openings 88, respectively. Each of the receiving spaces 16 is located between the corresponding protection portion 62 and the second connector 50 in the horizontal direction. Each of the receiving spaces 16 communicates with the opening 88 in the up-down direction and opens downward. Thus, the second structure 60 is formed with the two receiving spaces 16 which are located between the two protection portions 62 in the horizontal direction and correspond to the two protection portions 62, respectively. Each of the receiving spaces 16 is located inward of the corresponding protection portion 62 in the horizontal direction and is adjacent to the corresponding protection portion 62 in the horizontal direction.

According to the present embodiment, the receiving spaces 16 are formed as described above. However, the present invention is not limited thereto. For example, the receiving spaces 16 may be formed as necessary.

Hereafter, explanation will be made about the mating assist mechanism 18 (see FIG. 1) of the present embodiment.

Referring to FIG. 1, the mating assist mechanism 18 of the present embodiment comprises an informing mechanism in addition to a guide mechanism. The guide mechanism is configured to guide the mating of the first connector 20 and the second connector 50. The informing mechanism is configured to generate the click feeling when the first connector 20 and the second connector 50 are mated with each other. The guide mechanism mainly comprises the guide portions 34 of the first structure 30. The informing mechanism mainly comprises the first pieces 37 of the first structure 30 and the second pieces 64 of the second structure 60.

Hereafter, explanation will be made about the guide mechanism of the present embodiment.

Referring to FIG. 15 together with FIGS. 13 and 14, during a mating process in which the second connector 50 is mated with the first connector 20, the guide portions 34 are moved toward the receiving spaces 16, respectively. If the guide portions 34 are displaced from proper positions in the horizontal direction, one of the guide portions 34 is brought into abutment with an inner end of the protection portion 62 in the horizontal direction. Meanwhile, the guide portion 34 receives a force directed inward in the horizontal direction from an inclined surface formed on the end of the protection portion 62 and is moved toward the proper position in the receiving space 16. Thus, when the second connector 50 is mated with the first connector 20, the two protection portions 62 guide the two guide portions 34, respectively, so that the two guide portions 34 are received in the two receiving spaces 16, respectively.

Referring to FIG. 4, the two openings 88 are located at positions in the horizontal plane which correspond to positions of the two guide portions 34 in the horizontal plane, respectively. When seen from above, the two openings 88 have shapes which are similar to outlines of the two guide portions 34, respectively, and are larger than the outlines of the two guide portions 34, respectively. According to this configuration, the guide portions 34 received in the receiving spaces 16 are then inserted into the openings 88, respectively. As a result, the second connector 50 is positioned relative to the first structure 30 in the horizontal plane.

According to the present embodiment, the upward projecting guide portions 34 are received in the openings 88 so that the second connector 50 is positioned. According to this positioning, the second connector 50 can be positioned while a size between the first object 40 and the second object 80 in the up-down direction under the mated state is not made large. Moreover, this positioning can be performed while the guide portions 34 are viewed through the openings 88.

The guide mechanism of the present embodiment works as described above. However, the present invention is not limited thereto. For example, in an instance in which each of the guide portions 34 has a small size in the up-down direction, the openings 88 do not need to be provided. The receiving spaces 16 may be defined by the protection portions 62 as necessary.

Referring to FIGS. 7, 8 and 11, each of the guide portions 34 of the present embodiment has a guide surface 342. Each of the guide surfaces 342 is an inner surface of the guide portion 34 in the horizontal direction. The two guide surfaces 342 are recessed away from each other in the horizontal direction. In detail, each of the guide surfaces 342 is widened upward and outward in the horizontal plane.

Referring to FIG. 11 together with FIG. 14, even if the second connector 50 is displaced in the horizontal plane at the time when the guide portions 34 are partially received in the openings 88, the second connector 50 are guided by the guide surfaces 342 and is moved toward the middle of the accommodation portion 33 in the horizontal plane. Thus, the guide surfaces 342 guide the opposite end portions 52 of the second connector 50 in the horizontal direction, respectively, when the second connector 50 is mated with the first connector 20 (see FIG. 5).

Referring to FIG. 14, according to the present embodiment, when the second connector 50 is mated with the first connector 20 (see FIG. 5), a first positioning is performed by the guide portions 34, the receiving spaces 16 and the openings 88. Referring to FIG. 11, a second positioning is then performed by the guide surfaces 342 of the guide portions 34 and the opposite end portions 52 of the second connector 50. However, the present invention is not limited thereto. For example, the guide surfaces 342 may be provided as necessary.

Summarizing the explanation described above with reference to FIGS. 2 and 3, the guide portions 34 is configured to guide the second connector 50 toward the first connector 20 when the second connector 50 is mated with the first connector 20. The second connector 50 guided by the guide portions 34 can be mated with the first connector 20 while being accurately positioned relative to the first connector 20 in the horizontal plane.

In general, it is difficult to mate two small connectors mounted on two circuit boards, respectively, with each other. However, according to the present embodiment, since the guide mechanism is provided, a user who is not mature in the mating operation can easily mate the first connector 20 and the second connector 50 with each other even in an instance in which the first connector 20 and the second connector 50 are small.

Hereafter, explanation will be made about the informing mechanism of the present embodiment.

Referring to FIGS. 5 and 6, each of the first pieces 37 has a first protrusion 372. Each of the first protrusions 372 protrudes outward in the horizontal direction. Thus, the two first protrusions 372 project so as to be away from each other in the horizontal direction. Each of the second pieces 64 has a second protrusion 642. Each of the second protrusions 642 protrudes inward in the horizontal direction. Thus, the two second protrusions 642 project toward each other in the horizontal direction. The two second protrusions 642 are provided so as to correspond to the two first protrusions 372, respectively. The first protrusion 372 and the second protrusion 642 corresponding to each other project toward each other in the horizontal direction.

As shown in FIG. 6A, when the first connector 20 and the second connector 50 are under the separated state illustrated in FIG. 2, each of the second protrusions 642 is located above the corresponding first protrusion 372. Each of the second protrusions 642 has an end which is located just over the corresponding first protrusion 372. As shown in FIG. 6B, each of the second protrusions 642 is brought into abutment with the corresponding first protrusion 372 in the mating process in which the first connector 20 and the second connector 50 are mated with each other. Meanwhile, each of the second pieces 64 is resiliently deformed, and each of the second protrusions 642 is moved inward in the horizontal direction. As shown in FIG. 6C, when the first connector 20 and the second connector 50 are mated with each other (see FIG. 5), each of the second pieces 64 tries to return to an initial state before resilient deformation, and each of the second protrusions 642 is located below the corresponding first protrusion 372. The click feeling is generated during a process in which each of the second pieces 64 tries to return to the initial state.

Summarizing the explanation described above with reference to FIGS. 5 and 6, at least one of the first piece 37 and the second piece 64 is resiliently deformable. When the second connector 50 is mated with the first connector 20, the first protrusion 372 and the second protrusion 642 are brought into abutment with each other and then pass over each other along the up-down direction in accordance with resilient deformation of at least one of the first piece 37 and the second piece 64, and thereby the click feeling is generated.

The thus-generated click feeling clearly informs a user that the first connector 20 and the second connector 50 are mated with each other. Moreover, each of the first pieces 37 and the second pieces 64 of the present embodiment can be formed separately from the first connector 20 and the second connector 50. In general, even in an instance in which the first connector 20 and the second connector 50 are provided with a portion configured to generate a click feeling, a user who is not mature in the mating operation hardly detects the click feeling if the first connector 20 and the second connector 50 are small. In contrast, according to the present embodiment, an intense click feeling can be generated by enlarging the size of each of the first pieces 37 and the second pieces 64. Thus, the present invention provides the mating assist mechanism 18 (see FIG. 1) configured to assist the mating operation performed by a user who is not mature in the mating operation.

Referring to FIG. 5, according to the present embodiment, the mating assist mechanism 18 (see FIG. 1) is provided with two sets each of which consists of the first piece 37 and the second piece 64 corresponding to each other. Accordingly, the generated click feeling can be made more intense. According to the present embodiment, the first piece 37 is hardly deformed resiliently, while the second piece 64 is easily deformed resiliently. However, the present invention is not limited thereto. For example, the first piece 37 may be easily deformed resiliently, while the second piece 64 may be hardly deformed resiliently. Instead, each of the first piece 37 and the second piece 64 may be easily deformed resiliently. Under the mated state, each of the first piece 37 and the second piece 64 may return to the initial state or may remain resiliently deforming to some extent.

Referring to FIG. 15, the two openings 88 are provided so as to correspond to the second pieces 64, respectively. Each of the openings 88 is located inward of the corresponding second piece 64 in the horizontal direction. Each of the second pieces 64 extends upward in the corresponding opening 88 beyond the lower surface of the second object 80 and then extends downward beyond the lower surface of the second object 80. According to this configuration, each of the second pieces 64 has a long spring length. For example, each of the second pieces 64 may pass through the opening 88 in the up-down direction. According to this configuration, each of the second pieces 64 may have a longer spring length.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A mating assist mechanism configured to assist a mating operation of a first connector and a second connector which are mounted on a first object and a second object, respectively, and are mateable with each other along an up-down direction, wherein:
the mating assist mechanism comprises a first structure configured to be attached to the first object and a second structure configured to be attached to the second object;
the first structure comprises two guide portions and at least one first piece;
the second structure comprises at least one second piece;
the guide portion is configured to guide the second connector toward the first connector when the second connector is mated with the first connector;
at least one of the first piece and the second piece is resiliently deformable;
the first piece has a first protrusion;
the second piece has a second protrusion; and
when the second connector is mated with the first connector, the first protrusion and the second protrusion are brought into abutment with each other and then pass over each other along the up-down direction in accordance with resilient deformation of the at least one of the first piece and the second piece, and thereby a click feeling is generated.

2. The mating assist mechanism as recited in claim 1, wherein:
the at least one first piece includes two first pieces;
the at least one second piece includes two second pieces which correspond to the two first pieces, respectively;
the two second pieces are apart from each other in a horizontal direction perpendicular to the up-down direction;
each of the second pieces is resiliently deformable;
the second structure comprises two protection portions which correspond to the two second pieces, respectively;
each of the protection portions is adjacent to a corresponding one of the second pieces; and
each of the protection portions protects the corresponding one of the second pieces when the second connector is mated with the first connector.

3. The mating assist mechanism as recited in claim 2, wherein:
each of the protection portions is adjacent to the corresponding one of the second pieces in an intersecting direction perpendicular to the up-down direction and intersecting with the horizontal direction;
the second structure is formed with two receiving spaces which are located between the two protection portions in the horizontal direction and correspond to the two protection portions, respectively;
each of the receiving spaces is adjacent to a corresponding one of the protection portions in the horizontal direction; and
when the second connector is mated with the first connector, the two protection portions guide the two guide portions, respectively, so that the two guide portions are received in the two receiving spaces, respectively.

4. The mating assist mechanism as recited in claim 2, wherein:
the second structure is configured to be mounted on a lower surface of the second object;
the second object is formed with two openings;
each of the openings passes through the second object in the up-down direction;
the two openings are provided so as to correspond to the two second pieces, respectively;
each of the openings is located inward of a corresponding one of the second pieces in the horizontal direction; and
each of the second pieces extends upward in a corresponding one of the openings beyond the lower surface of the second object and then extends downward beyond the lower surface of the second object.

5. The mating assist mechanism as recited in claim 2, wherein:
the second structure comprises at least one coupling portion; and
the coupling portion couples the two protection portions together in the horizontal direction.

6. The mating assist mechanism as recited in claim 5, wherein:
the at least one coupling portion includes two coupling portions; and
each of the coupling portions couples the two protection portions together in the horizontal direction.

7. The mating assist mechanism as recited in claim 5, wherein:
the second structure comprises an extending portion;
the extending portion extends from the coupling portion along an extending direction so as to be located inside the second structure, the extending direction being perpendicular to the up-down direction and intersecting with the horizontal direction; and
the extending portion is formed with a broken portion located at an end thereof.

8. A predetermined member usable as the second structure of the mating assist mechanism as recited in claim 1, wherein:
the predetermined member comprises two second pieces, two protection portions corresponding to the two second pieces, respectively, a coupling portion, an extending portion and a suckable portion;
the two second pieces are apart from each other in a horizontal direction;
each of the second pieces is resiliently deformable;
each of the protection portions is adjacent to a corresponding one of the second pieces in an intersecting direction intersecting with the horizontal direction;
the coupling portion couples the two protection portions together in the horizontal direction;
the extending portion extends from the coupling portion along an extending direction so as to be located inside the predetermined member, the extending direction intersecting with the horizontal direction; and
the suckable portion is connected to the extending portion, is located between the two protection portions in the horizontal direction and extends along a horizontal plane defined by the horizontal direction and the intersecting direction.
